(19) United States
(12) Patent Application Publication
(10) Pub. No.: US 2008/0283585 A1
(43) Pub. Date: Nov. 20, 2008

(54) SELECTIVE LAUNDERING SYSTEMS AND METHODS

(76) Inventors: Carol Peterman, Seattle, WA (US); David Peterman, Seattle, WA (US)

Correspondence Address: AXIOS LAW GROUP. PLLC, 1525 FOURTH AVENUE, SUITE 800, SEATTLE, WA, 98101, US

(21) Appl. No.: 11/948,951

(22) Filed: Nov. 30, 2007

Related U.S. Application Data
(60) Provisional application No. 60/868,346, filed on Dec. 3, 2006.

(51) Int. Cl. G06F 17/00

(52) U.S. Cl. 235/375

(57) ABSTRACT

Systems and methods are provided herein that provide for selective laundering.

### RELATED REFERENCES

This application claims priority to U.S. Provisional Application 60/868,346 filed Dec. 3, 2006. The foregoing application is hereby incorporated by reference in its entirety as if fully set forth herein.

### FIELD

This invention relates generally to laundering, and more specifically, to systems and methods for selective laundering

### BACKGROUND

Clothing is estimated to have been used by early man as long as 100,000 years ago, if not earlier, and therefore cleaning or laundering such garments has also likely been a necessity since that time. Laundry was first done by soaking garments in streams or other bodies of water, combined with rubbing and twisting the garments to remove dirt and other stains. Natural surfactants such as, soap-root, yucca-root or lye were also used to increase the solvent power of water.

Today, with the advent of modern textiles and the expectation that cleaning garments will not significantly alter or deteriorate them, laundry has become a much more complex endeavor. For example, many clothes must be washed with other clothes that are of a similar color so that the clothing pigments of one garment do not color another garment while being washed, which means that colored clothing and white clothing must be washed separately. Additionally, many textiles will deform, shrink or melt if washed or dried at certain temperatures, and others are so delicate that they cannot be washed or dried in a machine at all.

Typically, a person doing laundry starts with a pile of garments and must manually sort and group garments that can be washed or dried together and selectively remove garments that cannot be machine washed; additionally, after washing, garments must also be sorted and separated if they have special drying requirements. Clearly, this is a time-consuming and tedious process, especially given that many garments have special laundering requirements. Unfortunately, despite being cumbersome, sorting garments according to laundering requirements is essential to the proper maintenance and care of garments and prevents the destruction of garments due to improper laundering.

Sorting laundry can be especially difficult when a plurality of people are laundering their garments together or when laundering is being performed by multiple individuals or unskilled individuals. For example, families commonly have difficulty when one member of the family is ignorant of proper laundering techniques or simply careless with the garments of others and either ruins them or damages them.

There are some proposed solutions to this problem in the art; however, these proposed solutions are also cumbersome and difficult to use, especially by unsophisticated users or multiple users. For example, one exemplary system is an inventory system that comprises a plurality of RFID tags that can be programmed with a multitude of distinct information about a given article of clothing and coupled to that article of clothing. A user can then receive information about clothing during or before laundering. This system is, however, deficient for many reasons.

First, for this system to be effective, every single piece of clothing must be labeled, and information must be input or programmed regarding each and every garment, which is cumbersome and especially difficult for individuals who are not proficient with the process of programming RFID tags. Additionally, this system is deficient because the RFID tags must each be programmed for each garment, and must be permanently coupled to the garment.

### BRIEF DESCRIPTION OF THE DRAWINGS

The present invention will be described by way of exemplary embodiments but not limitations, illustrated in the accompanying drawings in which like references denote similar elements, and in which:

FIG. 1 is a block diagram of an RFID system in accordance with an embodiment.

FIG. 2 is a front elevational view of a washer and dryer, in accordance with an embodiment.

FIG. 3 is an elevational view of an RFID clip, in accordance with an embodiment.

FIG. 4 is an elevational view of an RFID pin, in accordance with an embodiment.

FIG. 5 is an elevational view of an RFID unit, in accordance with an embodiment.

FIG. 6 is a block diagram of a method of selective laundering, in accordance with an embodiment.

FIG. 7 depicts a system for providing selective laundering in accordance with an embodiment.

FIG. 8 depicts a further system for providing selective laundering in accordance with an embodiment.

### DESCRIPTION

Illustrative embodiments presented herein include, but are not limited to, systems and methods for selective laundering

Various aspects of the illustrative embodiments will be described using terms commonly employed by those skilled in the art to convey the substance of their work to others skilled in the art. However, it will be apparent to those skilled in the art that the embodiments described herein may be practiced with only some of the described aspects. For purposes of explanation, specific numbers, materials and configurations are set forth in order to provide a thorough understanding of the illustrative embodiments. However, it will be apparent to one skilled in the art that the embodiments described herein may be practiced without the specific details. In other instances, well-known features are omitted or simplified in order not to obscure the illustrative embodiments.

Further, various operations and/or communications will be described as multiple discrete operations and/or communications, in turn, in a manner that is most helpful in understanding the embodiments described herein; however, the order of description should not be construed as to imply that these operations and/or communications are necessarily order dependent. In particular, these operations and/or communications need not be performed in the order of presentation.

The phrase “in one embodiment” is used repeatedly. The phrase generally does not refer to the same embodiment; however, it may. The terms “comprising,” “having” and “including” are synonymous, unless the context dictates otherwise.

Radio frequency identification (“RFID”) systems and components are well known in the art, and various types or embodiments of RFID systems or components known or yet unknown in the art are within the scope of various embodiments. The following description provides exemplary RFID systems that are within the scope of various embodiments, and should not be construed to limit or otherwise narrow the scope of the possible RFID systems or components that can be used in various embodiments or that are within the scope of various embodiments. Additionally, although RFID systems and components are one type of technology that can perform the functions of various embodiments, other technologies either known or unknown can be employed to perform the functions of various embodiments, and therefore, the scope of the exemplary embodiments should not be construed to be limited to RFID technology only, but should also be construed to include various types of technology that is similar to RFID technology, such as a global positioning system, cellular telephone network, wide fidelity (Wi-Fi) network, or the like

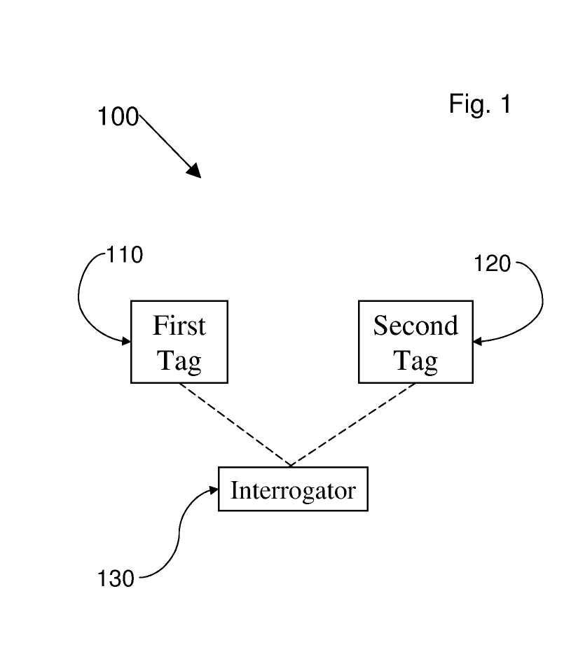

FIG. 1 is a block diagram of a radio frequency identification (“RFID”) system 100 in accordance with an embodiment, which comprises a first tag 110, a second tag 120 and an interrogator 130. The first and second tag 110, 120 can comprise a transponder with a digital memory chip that can hold or store one or more piece of information or data. The interrogator 130 can comprise an antenna with a transceiver and can emit an electromagnetic signal. The first and second tag 110, 120 are configurable to detect an electromagnetic signal emitted the interrogator 130, whereby the first and second tag 110, 120 can be activated and the one or more piece of information or data stored on the first or second tag 110, 120 can be read by the interrogator 130.

In one embodiment, there can be one or more tag that can be read by one or more interrogator 130 and the one or more interrogator 130 can read one or more tag. In a still further embodiment, the interrogator 130 is configurable to only read a tag that comes within a given radius or other defined field in relation to the interrogator 130. In a still further embodiment, there can be two or more tags, and the two or more tags can store or hold one or more piece of information, which can be different, similar, or exactly the same as any other of the two or more tags.

In a still further embodiment, the interrogator 130 can be configured to present or display one or more alert to a user and the one or more alert can include, but is not limited to a visual, auditory, olfactory, tactile, or gustatory alert such as a light, a flashing light, a buzzer, an alarm, a bell, a sound, a vibration, or a display on a screen, which can include a number, letter or symbol. Additionally, in one embodiment the interrogator 130 can be configured to display or present a different alert depending on the data or information that is stored or held in one or more tag. For example, if the first tag 110 stores or holds a first piece of information, and the second tag 120 holds a second piece of information that is different from the first piece of information, the interrogator 130 can be configured to display a first alert when the first tag 110, or any tag that holds or stores the first piece of information, is read by the interrogator 130. Similarly, the interrogator 130 can also be configured to display or present a second alert when the second tag 120, or any tag that holds or stores the second piece of information is read by the interrogator 130. In a still further embodiment, the interrogator 130 is configurable to present or display no alert when a selected piece of information is read from or detected on a tag.

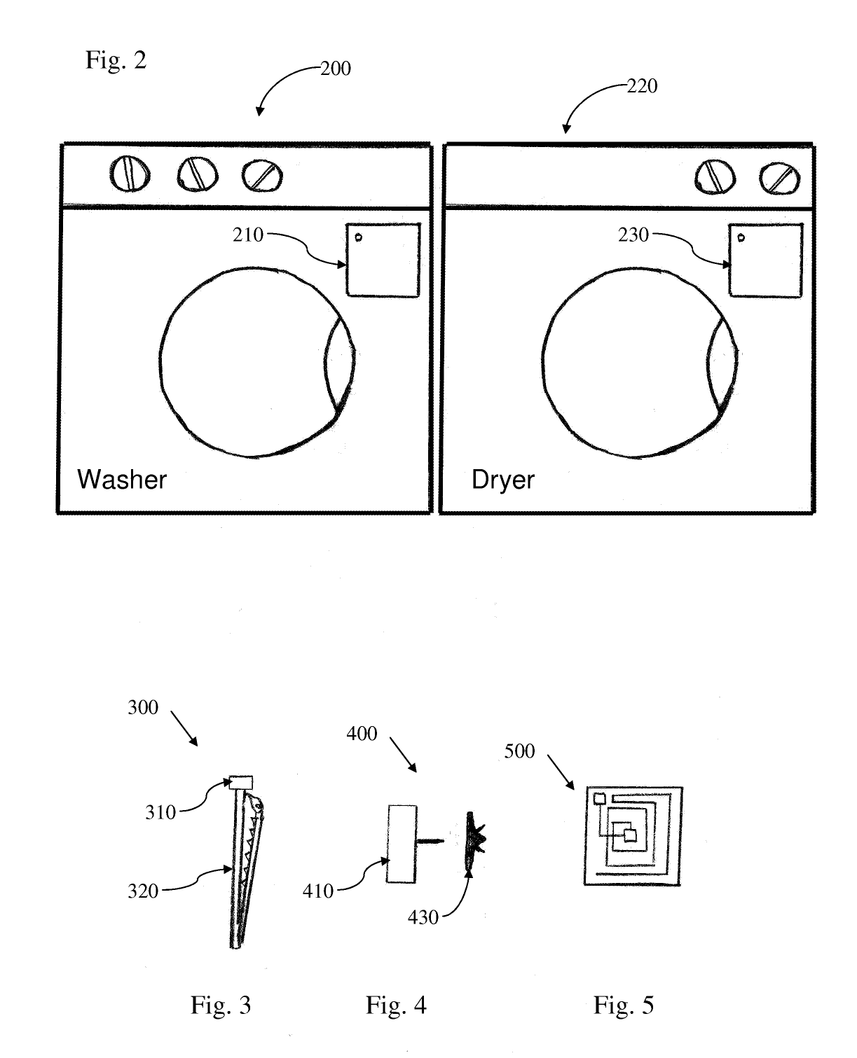

FIG. 2 is a front elevational view of a washer 200 and dryer 220, in accordance with an embodiment. The washer 200 comprises a washer interrogator 210 and the dryer 220 comprises a dryer interrogator 230. The washer interrogator 210 and dryer interrogator 230 are configurable to read, detect, or otherwise be in communication with one or more RFID tag and to provide or display one or more alert when one or more selected tag is in relative proximity to either the washer 200 or dryer 220. Both of the washer and dryer interrogator 210, 230 are configurable to detect, read, or otherwise be in communication with one or more tag within various distances, radii, fields, or the like, in relation to the washer interrogator 210 or the dryer interrogator 230, such as within 20, 15, 10, 9, 8, 7, 6, 5, 4, 3, 2, 1, 0.75, 0.5, 0.25, 0.20, 0.10, 0.5 meters or the like. Additionally, the washer and dryer interrogator 210, 230 are configurable to read, detect or otherwise be in communication with one or more tag that is within a selected field in relation to the washer or dryer interrogator 210, 230 such as a plane, cardioid pattern, circle, sphere, oval, cylinder, ellipsoid, spheroid, hyperboloid, parabolid, platonic solid, hyperplane, mobius strip, or Bezier triangle. In another embodiment, the washer and dryer interrogator 210, 230 can be configured to read, detect or otherwise be in communication with one or more tag that is within the orifice of the washer or dryer 200, 220 or within the washing or drying containers of the washer or dryer 200, 220.

In one embodiment, one or more RFID tag can be coupled to an article of clothing or other article of manufacture, whereby the tag is associated with the article of clothing or article of manufacture either permanently, semi-permanently, or temporarily. When the tag that is coupled to the article of clothing or other article of manufacture passes into a position where the tag can be read, detected or otherwise communicate with either the washer or dryer interrogator 210, 230 the washer or dryer interrogator 210, 230 can generate an alert for a user, which signals to the user that the tag, and therefore the article of clothing or manufacture, is in proximity to the washer or dryer 200, 220, that the article of clothing or manufacture is within the washer or dryer 200, 220 or that the article of clothing or manufacture is in the orifice of the washer or dryer 200, 220. For example, if a user desires that a specific shirt not be washed in the washer 200 or dried in the dryer 220, the user can couple an RFID tag to the shirt so that the user will receive an alert if the shirt has been placed in the washer or dryer 200, 220 or that the shirt is being placed in the washer or dryer 200, 220. In one embodiment, the washer or dryer interrogator 210, 230 can be absent.

In yet another embodiment, the washer or dryer interrogator 210, 230 can be activated when the door of the washer or dryer 200, 220 is opened. For example, the dryer interrogator 230 can be off, powered down, on standby or configured to not give an alert when the door of the dryer 220 is closed or shut; however, when the door to the dryer 200 is opened or is open, the act of opening the door can configure the dryer interrogator 230 to be tuned on, powered-up, removed from a standby mode, or otherwise configured to provide an alert. In another embodiment, the washer or dryer interrogator 210, 230 is configurable to not provide an alert, be turned off, or be in standby, when other conditions are present, including but not limited, the washer or dryer 200, 220 being off or unplugged, when the washer or dryer 200, 220 are not in use, when there is not movement near the washer or dryer 200, 220, or when the washer or dryer 200, 220 are set to certain washing or drying settings or cycles.

In a still further embodiment, the washer interrogator 210 can be coupled to any part of the washer 200 and any part of the dryer interrogator 230 can be coupled to the dryer 220 by various systems or methods known in the art, including but not limited to, a magnet, Velcro®, hook, clasp, adhesive, pin and slot, hinge, latch, or one or more screw. In another embodiment, an interrogator can be an integral part of a washer or dryer 200, 220. In a still further embodiment, an interrogator can be coupled to various articles of manufacture, appliances, or machines, including a microwave, refrigerator, door, window, table saw, blender, steamer, toilet, or dry cleaning machine.

FIG. 3 is an elevational view of an RFID clip, 300 in accordance with an embodiment, which comprises an RFID tag 310 and a clip 320. The RFID clip 300 can be coupled to an article of clothing or article of manufacture and thereby associate the RFID tag 310 with the article of clothing or article of manufacture.

FIG. 4 is an elevational view of an RFID pin 400, in accordance with an embodiment, which comprises an RFID tag with a pin 410 and a pin clasp 420. The RFID pin 400 can be coupled to an article of clothing or article of manufacture thereby associating the RFID tag 410 with the article of clothing or article of manufacture.

FIG. 5 is an elevational view of an RFID unit 500, in accordance with an embodiment, which can be coupled to an article of clothing or article of manufacture either permanently, semi-permanently, or temporarily. The RFID unit 500 can be coupled to an article of clothing or article of manufacture by various systems or methods known in the art, including but not limited to sewing, an adhesive, a pin, a clip, a button, incorporation into a button, a clasp, or by placing the RFID unit 500 into a pocket of an article or clothing or other article of manufacture. In another embodiment, the RFID unit 500 can be coupled to various articles associated with a living being, or the living being itself such as, a dog, cat, dog collar, or cat collar.

In another embodiment, the RFID unit 500 is configurable to provide an alert to a user when the RFID unit 500 is in proximity to, read by, detected by or otherwise in communication with an RFID interrogator. In a still further embodiment, the RFID unit 500 is configurable to selectively provide an alert when the RFID unit 500 is in proximity to, read by, detected by or otherwise in communication with an RFID interrogator.

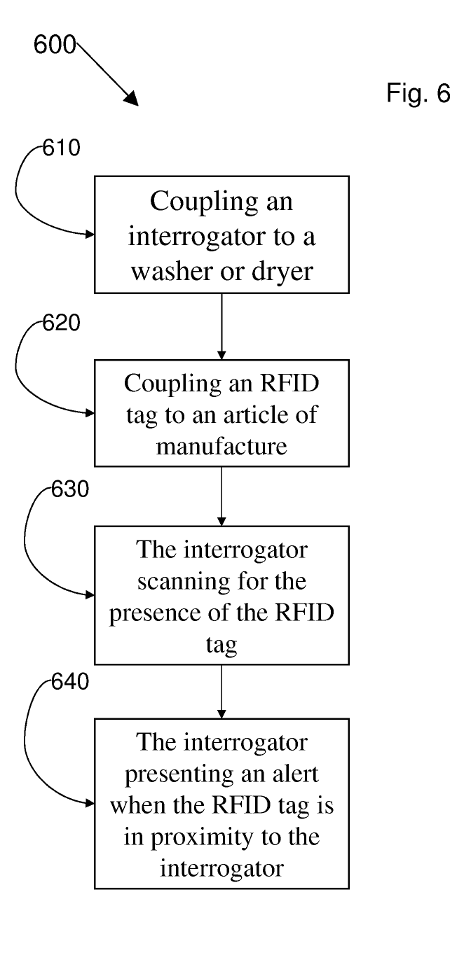

FIG. 6 is a block diagram of a method of selective laundering 600, in accordance with an embodiment, which comprises the steps of coupling an interrogator to a washer or dryer 610; coupling an RFID tag to an article of manufacture 620; the interrogator scanning for the presence of the RFID tag 630; and the interrogator presenting an alert when the RFID tag is in proximity to the interrogator 640. In one embodiment an interrogator can be coupled to both a washer or dryer or only a washer or only a dryer.

In one embodiment of this method a user can first couple an interrogator to a dryer 610 with a magnet, which is coupled to the back of the interrogator. The user can then selectively couple an RFID tag to articles of clothing 620 that the user desires not to have dried in the dryer and selectively not couple an RFID tag to articles of clothing that the user desires to have dried in the dryer. The user can wash a load of clothes, which can comprise one or more article of clothing that has an RFID tag coupled to it. The interrogator that is coupled to the dryer can scan for the presence of one or more RFID tag 630, but if there are not any RFID tags in the washer, the interrogator will not provide an alert because the interrogator is configured to only detect or provide an alert when one or more RFID tag is in close proximity to the dryer, such as in the orifice of the dryer or within the dryer itself. When the user desires to dry the load of clothes that has been washed in the washer, the user can remove one or more article of clothing from the washer an place it in the dryer. If the user places an article of clothing within the orifice of the dryer or within the dryer itself, the interrogator that is scanning for the presence of an RFID tag 630, will present an alert 640 to the user. Upon hearting the alert, the user is alerted to the fact that an RFID tag is present in the dryer, and therefore that there is an article of clothing in the dryer that the user does not desire to dry or have dried in the dryer. The user can then remove the article of clothing from the dryer. In another embodiment, the user can couple an interrogator to a washer and dryer and receive an alert when there is an RFID tag in either the washer or dryer.

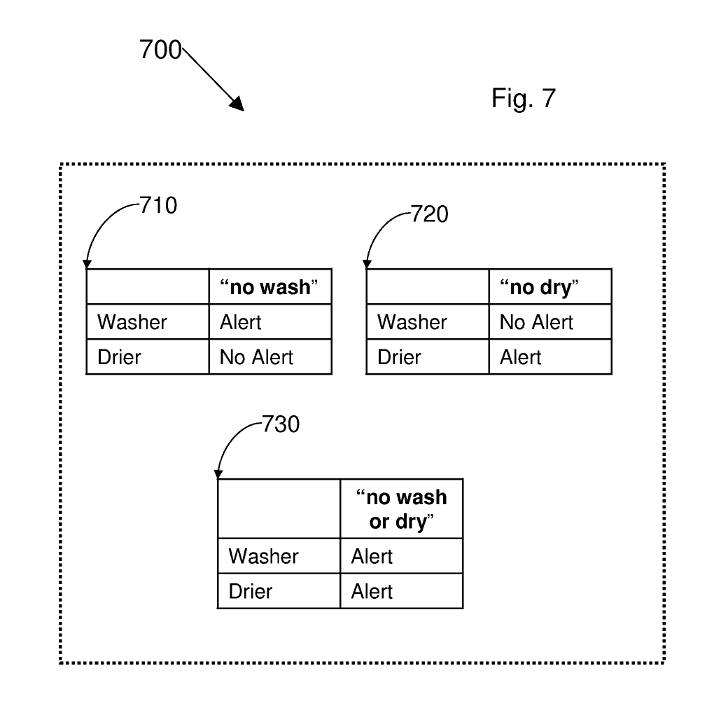

FIG. 7 depicts a system for providing selective laundering in accordance with an embodiment, which comprises a ‘no wash’ tag 710, a ‘no dry tag’ 720, and a ‘no wash or dry’ tag 730. In one embodiment, there can be a first interrogator that is designated as a dryer interrogator and a second interrogator that is designated as a washer interrogator.

In another embodiment, there can be one or more interrogator that comprises a selection system that makes the interrogator configurable to be either a washer or dryer interrogator. The selection system can be selected from various selection systems known in the art, such as one or more button, switch, or screen. For example, when the one or more interrogator is coupled to a washer, a user can configure the one or more interrogator to be a washer interrogator by configuring, actuating, flipping, or pressing a switch or button. In another example, a user can configure an interrogator to be a washer interrogator when the user is using the washer and couple the interrogator to the washer; then, the user can configure the interrogator to be a dryer interrogator when the user is using the dryer and couple the interrogator to the dryer. In a still further example, a user can have a first and second interrogator, and the first interrogator can be coupled to a washer and configured to be a washer interrogator and the second interrogator can be coupled to a dryer and configured to be a dryer interrogator.

The ‘no wash’ tag 710 is configured to cause a washer interrogator to provide an alert when the ‘no wash’ tag 710 is in the washer, but not cause a dryer interrogator to provide an alert when the ‘no wash’ tag 710 is in the dryer. The ‘no dry’ tag 720 is configured to cause a dryer interrogator to provide an alert when the ‘no dry’ tag 720 is in the dryer, but not cause a washer interrogator to provide an alert when the ‘no dry’ tag 720 is in the washer. The ‘no wash or dry’ tag 730 is configured to cause a dryer interrogator to provide an alert when the ‘no wash or dry’ tag 730 is in the dryer, and to cause a washer interrogator to provide an alert when the ‘no wash or dry’ tag 730 is in the washer. In one embodiment, the ‘no wash’ tag 710, the ‘no dry tag’ 720, and the ‘no wash or dry’ tag 730, are not configurable by a user, in other words, the tags 710, 720, 730 are pre-programmed and cannot be changed by a user.

In one embodiment, a user can use the system depicted in FIG. 7 to differentiate between laundry that can be (1) washed and dried; (2) washed but cannot be dried; (3) not washed but can be dried; and (4) neither washed nor dried. At any time before washing or drying, a user can couple either the ‘no wash’ tag 710, the ‘no dry tag’ 720, or the ‘no wash or dry’ tag 730 to an article of clothing, or not affix a tag to the article of clothing. When the user is loading the washer, the washer interrogator can alert the user if the user has put an article of clothing in the washer that has a ‘no wash’ tag 710 or a ‘no wash or dry’ tag 730. When the user is loading the dryer, the dryer interrogator can alert the user if the user has put an article of clothing in the dryer that has a ‘no dry’ tag 720 or a ‘no wash or dry’ tag 730.

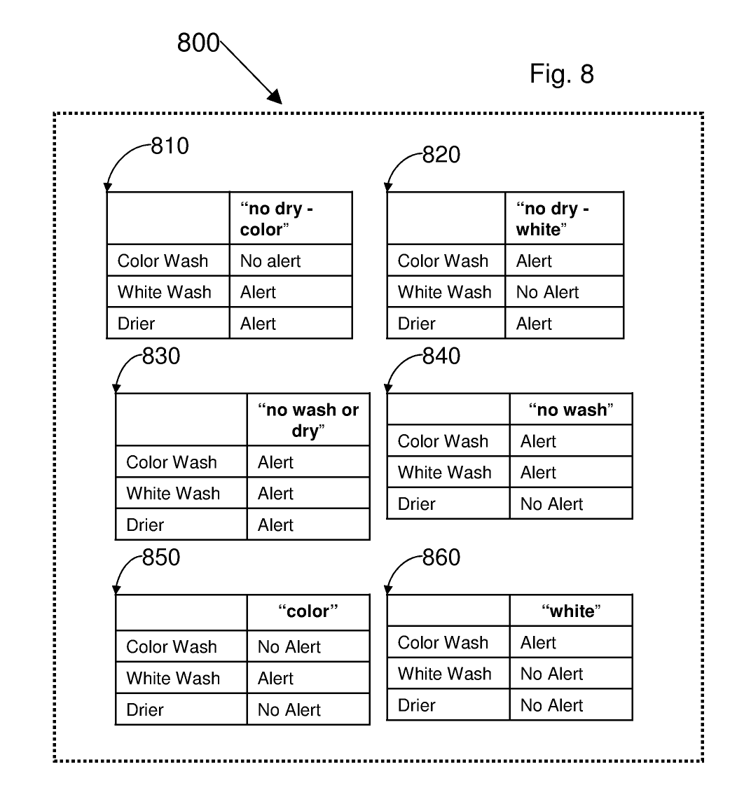

FIG. 8 depicts a further system for providing selective laundering 800 in accordance with an embodiment, which comprises a ‘no dry—color’ tag 810, a ‘no dry—white’ tag 820, a ‘no wash or dry’ tag 830, and a ‘no wash’ tag 840. In one embodiment, there can be a first interrogator that is designated as a dryer interrogator and a second interrogator that is designated as a washer interrogator. The washer interrogator is configurable to detect whether the washer is set to wash a load of colored clothing or whether the washer is set to wash a load of white clothing. In one embodiment the washer and or dryer interrogator can be an integral part of the washer or dryer.

The ‘no dry—color’ tag 810 is configured to cause a dryer interrogator to provide an alert when the ‘no dry—color’ tag 810 is in the dryer and to cause a washer interrogator to provide an alert when the washer is set to wash white clothing and the ‘no dry—color’ tag 810 is in the washer.

The ‘no dry—white’ tag 820 is configured to cause a dryer interrogator to provide an alert when the ‘no dry—white’ tag 820 is in the dryer and to cause a washer interrogator to provide an alert when the washer is set to wash color clothing and the ‘no dry—white’ tag 820 is in the washer.

The ‘no wash or dry’ tag 830 is configured to cause a dryer interrogator to provide an alert when the ‘no wash or dry’ tag 830 is in the dryer and to cause a washer interrogator to provide an alert when the ‘no wash or dry’ tag 830 is in the washer, regardless of whether the washer is set to wash colors, whites or otherwise.

The ‘no wash’ tag 840 is configured to cause a washer interrogator to provide an alert when the ‘no wash’ tag 840 is in the washer, regardless of whether the washer is set to wash colors or whites or otherwise and to not cause a dryer interrogator to provide an alert when the ‘no wash’ tag 840 is in the dryer,

The ‘color’ tag 850 is configured to not cause a dryer interrogator to provide an alert when the ‘color’ tag 850 is in the dryer and to cause a washer interrogator to provide an alert when the washer is set to wash white clothing and the ‘color’ tag 850 is in the washer.

The ‘white’ tag 860 is configured to not cause a dryer interrogator to provide an alert when the ‘white’ tag 860 is in the dryer and to cause a washer interrogator to provide an alert when the washer is set to wash color clothing and the ‘white’ tag 860 is in the washer.

In one embodiment a user can use the system depicted in FIG. 8 to differentiate between clothing that is colored or white, and clothing that can or cannot be dried or washed. For example, a user can couple the ‘no dry-color’ tag 810 to one or more article of colored clothing that should not be dried so that a dryer interrogator provides an alert when one or more article of colored clothing is present in the washer when the washer is set to wash white clothing and when the selected colored clothing is present in the dryer. In another example a user can couple a ‘no wash or dry’ 830 tag to clothing that should not be washed or dried, regardless of whether the washer is set to wash whites or colors so that both a washer and dryer interrogator will provide an alert if the clothing is present in the washer or dryer. In a further example, a user can couple a ‘no wash’ tag 840 to an article of clothing that should not be washed, regardless of whether the article of clothing is washed in a colors or whites cycle, so that a washer interrogator will provide an alert when the article of clothing is in the washer, regardless of whether the washer is set to wash whites or colors. In a still further example, a ‘color’ tag 850 can be coupled to a colored article of clothing such that a washer interrogator provides an alert when the article of clothing is in the washer and the washer is set to wash white clothing, but a dryer interrogator will not provide an alert when the article of clothing is present in the dryer.

In a still further embodiment, there can be a system of selective laundering that can facilitate selectively laundering an article of clothing according to one or more additional laundering variable, setting, or care necessity, including, but not limited to machine wash, washing temperature, permanent press wash, gentle wash, delicate wash, hand wash, do not wash, bleach when needed, non-chlorine bleach when needed, do not bleach, tumble dry, dry temperature, gentle dry, do not tumble dry, do not dry, line dry, drip dry, dry flat, dry in shade, do not wring, do not iron, iron temperature, do not steam, dry-clean, dry-clean any solvent, dryclean petroleum solvent, dry-clean except with trichloroethylene, short dryclean cycle, dry-clean reduced moisture, dry-clean low heat, dry-clean no steam, and do not dry-clean.

For purposes of illustration, terms such as ‘no wash or dry,’ ‘no dry,’ ‘no wash or dry,’ ‘no dry—color,’ ‘no dry—white,’ ‘no wash or dry,’ ‘no wash,’ ‘dryer interrogator,’ and ‘washer interrogator,’ have been used. Use of these terms should be construed as only being exemplary labels given to the elements being described and should not be construed to limit these elements to these labels in practical use or otherwise. Other labels such as ‘1’,‘2’,‘3’,‘4’,‘5’ or ‘A’,‘B’,‘C’,‘D’ can be used to describe these elements or any other symbol, letter, number, character, designation or representation can be used.

Additionally, although specific embodiments have been illustrated and described herein, it will be appreciated by those of ordinary skill in the art and others, that a wide variety of alternate and/or equivalent implementations may be substituted for the specific embodiment shown in the described without departing from the scope of the embodiments described herein. This application is intended to cover any adaptations or variations of the embodiment discussed herein. While various embodiments have been illustrated and described, as noted above, many changes can be made without departing from the spirit and scope of the embodiments described herein.

1. A system for selective laundering, the system comprising:
a first interrogator configured to provide a first interrogator alert and interrogate RFID tags; and
a plurality of RFID tags storing at least one piece of information,
wherein at least one RFID tag is configured to trigger a first interrogator alert when said RFID tag is in proximity of the first interrogator.

2. The system of claim 1, further comprising:
a second interrogator configured to provide a second interrogator alert and interrogate RFID tags; and
wherein at least one RFID tag is configured to trigger a second interrogator alert when said at least one RFID tag is in proximity of the second interrogator.

3. The system of claim 2, wherein at least one RFID tag is configured to trigger a second interrogator alert when said at least one RFID tag is in proximity of the second interrogator and trigger a first interrogator alert when said at least one RFID tag is in proximity of the first interrogator.

4. The system of claim 3, wherein said at least one piece of information stored on said plurality of RFID tags cannot be modified.

5. The system of claim 3, wherein said first interrogator is coupled to a washer.

6. The system of claim 5, wherein said first interrogator is coupled to said washer via a magnet.

7. The system of claim 5, wherein at least one of said plurality of RFID tags is configured to trigger a first interrogator alert when said at least one RFID tag is inside said washer.

8. The system of claim 5, wherein said second interrogator is coupled to a drier.

9. The system of claim 8, wherein said first interrogator is coupled to said washer via a magnet, and wherein said second interrogator is coupled to said drier via a magnet.

10. The system of claim 8, wherein at least one of said plurality of RFID tags is configured to trigger a second interrogator alert when said at least one RFID tag is inside said drier.

11. The system of claim 8, wherein at least one of said plurality of RFID tags is configured to trigger a second interrogator alert when said at least one RFID tag is inside said drier, and to trigger a first interrogator alert when said at least one RFID tag is inside said washer.

12. The system of claim 11, wherein said first or second interrogator alert is a buzzer.

13. The system of claim 3, wherein said first interrogator is incorporated into a washer.

14. The system of claim 13, wherein at least one of said plurality of RFID tags is configured to trigger a first interrogator alert when said at least one RFID tag is inside said washer.

15. The system of claim 13, wherein said second interrogator is coupled to a drier.

16. The system of claim 15, wherein at least one of said plurality of RFID tags is configured to trigger a second interrogator alert when said at least one RFID tag is inside said drier.

17. The system of claim 16, wherein at least one of said plurality of RFID tags is configured to trigger a second interrogator alert when said at least one RFID tag is inside said drier, and to trigger a first interrogator alert when said at least one RFID tag is inside said washer.

18. The system of claim 17, wherein said first or second interrogator alert is a buzzer.

19. The system of claim 3, wherein at least one RFID tag is coupled to an article of manufacture.

20. The system of claim 19, wherein said article of manufacture is an article of clothing.
